(19) United States
(12) Patent Application Publication
(10) Pub. No.: US 2010/0310246 A1
(43) Pub. Date: Dec. 9, 2010

(54) Method for using a variable aperture to tune image quality parameters in a camera system

(75) Inventor: Scott P. Campbell, Thousand Oaks, CA (US)

Correspondence Address: SAILE ACKERMAN LLC, 28 DAVIS AVENUE, POUGHKEEPSIE, NY, 12603, US

(73) Assignee: Digital Imaging Systems GmbH

(21) Appl. No.: 12/802,333

(22) Filed: Jun. 4, 2010

Related U.S. Application Data
(60) Provisional application No. 61/217,808, filed on Jun. 4, 2009.

(51) Int. Cl. G03B 13/00; G03B 7/085; G03B 11/00

(52) U.S. Cl. 396/89; 396/257; 396/544; 396/661

(57) ABSTRACT

In a camera system with a variable aperture, variations can be used to tune a variety of optical parameters otherwise incapable of being tuned within the structural limitations of the camera system or to optimize tradeoffs between competing factors such as diffraction limits and lens aberrations. For example, the variable aperture can be used to avoid overexposure or underexposure of an image due to improper illumination of an object. The variable aperture can be used to tune hyperfocal distance, enabling an accurate focus of an object to be obtained even if the camera lens is incapable of auto-focusing. In a camera with a lens having a focal length that varies with radial position from the lens center, the variable aperture can achieve the effect of auto-focus.

This application claims benefit of U.S. Provisional Patent Application Ser. No. 61/217,808, filed Jun. 4, 2009, which is herein incorporated by reference in its entirety and assigned to a common assignee.

### BACKGROUND OF THE INVENTION

1. Field of the Invention

This invention relates to a camera system and particularly to methods by which a variable aperture can be used to tune image quality parameters in such a system.

2. Description of the Related Art

In its simplest form the camera is an optical device that produces a permanent image on a film or a permanent or temporary image on a light sensitive sensor (hereinafter, film and light sensitive sensor are collectively referred to as a sensor). In use, the image is that of an object positioned at some distance in front of the camera. Light reflected from (or possibly emitted by) the object passes through a lens in the camera and is focused by that lens on the sensor. Generally, the sensor is a planar element that is placed at a certain distance behind the lens, typically at or slightly past the focal length of the lens, denoted f. The focal length is the position at which parallel rays of distant light will pass through the lens and converge to form a point.

A shutter is typically, but not always, positioned between the camera lens and the sensor. By the operation of opening and closing the shutter, which occurs within a selected amount of time, a corresponding amount of light is permitted to pass through the lens and impinge upon the sensor.

An adjustable aperture, typically interposed between the shutter and the sensor, or integrated in the shutter, also controls the amount of light striking the sensor by spatially restricting the amount that has passed through the lens. This spatial restriction is obtained by varying the area of the aperture opening, whereas the shutter imposes a temporal restriction on the light by varying the amount of time it remains open. Szajewski et al. (U.S. Pat. No. 7,310,477) describes a variable aperture camera having a primary lens and a micro lens array.

There are several ways that the area of the aperture opening can be adjusted, most commonly by use of a diaphragm that is mechanically or electrically controlled. Alternative shapes can also be used to construct the variable aperture, such as those proposed by Greenberg (U.S. Pat. No. 6,657,796).

The actual adjustment can be accomplished manually, such as by turning an external ring coupled to the aperture, or automatically, by means of light activated sensors within the body of the camera. Sophisticated light sensing systems have been provided to produce the proper opening for the aperture, for example, the systems of Saito et al. (U.S. Pat. No. 4,918,538), Keith et al. (U.S. Pat. No. 6,760,545) and Arai et al. (U.S. Pat. No. 5,115,319). Typically the area of the aperture opening can range from a maximum, which is the size (i.e., the area) of the lens itself, to some minimum, which is determined by the use to which the camera is to be put.

The area of the aperture opening is measured in terms of “f-stops” or “f-numbers.” These f-stops are assigned numerical values in the following standard sequence: f/1.0, f/1.4, f/2, f/2.8, f/4, f/5.6, f/8, f/11, f/16, f/22, f/32, f/45, f/64 and so on, where the smaller the f-stop, the larger is the aperture opening and the larger the f-stop, the smaller the opening. The numerical value assigned to an f-stop is determined by the ratio of the aperture's diameter to the focal length of the lens, so an f-stop of f/4 indicates that the ratio is 1:4, or, the aperture diameter is ¼ of the focal length of the lens. Thus, the actual physical size of an aperture is not an absolute quantity, but depends on the focal length of the lens. For example, a 50 mm lens (50 millimeters focal length) set at f/4 has an opening of 12.5 mm diameter through which light is admitted, whereas a 400 mm telephoto lens set at f/4 has an opening of 100 mm diameter. Thus a given f-stop setting will admit the same fraction of light through a lens regardless of its focal length.

A lens with a wide maximum aperture is called a “fast” lens, because it can admit a great deal of light. Such a lens can provide sufficient light to the sensor even with a shutter that stays open very briefly, i.e., a fast shutter.

A very compact camera might require a lens with a small focal length because the lens-to-film distance must be kept small. For example, if a camera with a 20 mm lens must have an f-stop of f/4, the lens should have a diameter of 5 mm. Norris (U.S. Pat. No. 3,977,014) shows a focusing system for determining aperture with lens focusing as a direct function of distance to the object.

A property of cameras that photographers use to control the “look” of their photographs is “depth-of-field”. Depth-of-field is the front-to-back distance range within which an object will still appear sharply defined on the sensor. If this distance is small, the camera is said to have a “shallow” depth of field, conversely, if the distance is large, the depth of field is “great.” Photographers can use depth-of-field to create film images in which a portion of the object is sharply focused on the film, whereas portions of the object closer and farther from this point of sharp object focus appear somewhat blurred. In “Optical super-resolution with aperture-function engineering,” E. Ramsay et al., Am. J. of Phys., 76(11) November 2008, pp. 1002-1006, there is a demonstration of the use of apertures to create improved resolution.

The rays of light emanating from a very distant object and entering the camera, after passing through the lens and aperture, will form a cone, with the apex of the cone striking the sensor precisely at a point if the sensor is at the focal length of the lens. If the object is not at a sufficient distance, the rays will not converge to the conical apex, or else will pass through the apex and diverge beyond it. In either case, instead of a point, the light forms a circle (called the circle of confusion) on the sensor within which the image is blurred.

This effect can “focus” the observer of the image's attention on the sharply defined portion, which might be the intention of the photographer. What is important for the photographer is the fact that the depth-of-field can be adjusted by use of the f-stop. Basically, this is because reducing the aperture size restricts the amount of light rays emanating from the object that can reach to film, which, in turn, narrows the cone of light and reduces the size of the circle of confusion away from best focus. Thus, reducing aperture size increases depth-of-field, while increasing aperture size reduces it.

The dependence of depth-of-field on aperture size is but one example of how a variable aperture can be used to tune properties of a camera to achieve an aesthetic effect. It will be the object of this invention to disclose methods of creating a variety of optical effects that are all produced by the variation of aperture size. In this way, the operational range and utility of a camera can be greatly increased and the user of even a basic camera with a minimum of controls is provided with a systematic methodology for achieving a multiplicity of physical and aesthetic effects.

Although many ingenious forms of variable aperture have been described in the art, the degree to which the variable aperture can be used to tune and enhance other properties of the camera system is not yet sufficiently appreciated. In particular, as cameras are increasingly miniaturized for incorporation in various electronic devices, such as cell phones and optical sensors, the myriad of controls found on larger sized cameras will be sacrificed. It is therefore advantageous to be able to apply the most basic of camera operations, the control of aperture size, to be able to create and enhance as wide a range of camera capabilities and properties as possible.

### SUMMARY OF THE INVENTION

It is the object of this invention to demonstrate simple and advantageous methods to control a wide variety of camera system characteristics by a novel use of only its aperture variability.

It is an additional object of the present invention to extend the capabilities of a camera by manipulation of aperture size and to thereby create an optical instrument with a wider range of image forming abilities than would be expected by nominal design restrictions and standard modes of operation.

It is yet an additional object of the present invention to optimize tradeoffs between competing factors such as diffraction limits and lens aberrations.

It is still an additional object of the present invention to utilize the capabilities of the variable aperture in concert with a lens property such as focal length that varies as a function of lens radius.

When a variable aperture is a part of the optical train of a camera system, adjusting the width or diameter of the aperture opening allows a number of system image quality parameters to be tuned. The ability to tune these parameters, in turn, allows system trade-offs to be made between operational characteristics of the camera such as exposure brightness, exposure time, motion blur, signal-to-noise ratio, modulation transfer function, depth of field, hyperfocal distance, focus, spatial filtering, relative illumination, color saturation, color accuracy, telecentricity and special effects. This tuning ability can be applied with particular advantage to camera systems that lack specific operational controls to directly affect these characteristics.

The following table summarizes the manner in which particular relationships between aperture variability and other camera properties, typically unexploited in normal operation that does not apply the methods of this invention, can be realized advantageously using those methods. In the remainder of the invention description, we will describe in greater detail a methodology for their implementation. Each of the desired camera operations listed in the first column of the table, can be realized using the properties of a variable aperture as listed in the second column.

| Desired Camera Operation | Realization with Variable Aperture |
|---|---|
| Exposure tuning | Close aperture down as object brightness |
| | increases. In this way compensation is |
| | permitted for macro flash over-exposure |
| Hyperfocal distance tuning | Hyperfocal distance moves in quadratically |
| | as f-number increases. This is useful for |
| | keeping close objects in focus in fixed- |
| | focus systems |
| Depth-of-field tuning | Depth-of-field increases as f-number |
| | increases, decreases as f-number decreases. |
| | This is useful for creating photographic |
| | effects and enhancing a subject in auto- |
| | focus systems |
| Focal length tuning | When used with a radially vari-focus lens, |
| | the variable aperture enables an auto-focus |
| | effect |
| Sensitivity/Resolution | During very-low-light operation, |
| tuning | decreasing the f-number can increase the |
| | sensitivity more quickly than it decreases |
| | the resolution due to aberration, thus image |
| | quality can be increased |
| Artifact tuning | Sharp focus creates a number of artifacts, |
| | like color aliasing and binning jagged |
| | edges. Increasing the f-number softens |
| | edges to reduce these artifacts |
| Motion blur tuning | Aberration blur from low f-numbers can be |
| | less than motion blur at higher f-numbers |
| | and longer exposures. This can produce |
| | the appearance of image stabilization |
| Aperture shading tuning | Relative illumination due to aperture |
| | shading can be tuned when the shutter's |
| | aperture and lens' pupil are axially |
| | separated |
| Directional blur tuning | An asymmetric aperture function can create |
| | asymmetric blur in the image plane |
| Telecentricity tuning | Varying an aperture that is not in the lens' |
| | pupil plane varies the telecentricity of the |
| | optical system and shifts the aberration |
| | trade space of the optical design |
| Special effects tuning | The aperture can open to allow light to pass |
| | through special effects filters in the optical |
| | path |

### BRIEF DESCRIPTION OF THE DRAWINGS

FIG. 1 is a schematic illustration showing the prior art relationship between the illumination of an object pixel and the resulting light intensity at the corresponding sensor pixel.

FIG. 2 is a prior art schematic illustration showing the role of flash-based object illuminance.

FIG. 3 is a schematic prior art illustration of a lens and sensor showing pictorially and mathematically the relationship between depth of field and depth of focus for a simple combination of object, lens and imaging sensor.

FIG. 4 is an analytic and graphical comparison of the Airy disk and a Gaussian beam and its relationship to depth of focus.

FIG. 5 is a schematic illustration showing the shape of the waist of a Gaussian beam for two exemplary f-numbers.

FIG. 6 is a graphical illustration showing the relationship between spot size and f-number in the application of a variable aperture to spot size tuning.

FIG. 7 is a graphical representation showing the relationship between optimal regions of focus for a lens with radially-varying focal length.

FIG. 8 is a graphical representation of the tradeoff between aberration limits and diffraction limits on a lens' spot size as an aperture is varied under low light conditions.

FIG. 9 is a schematic illustration of the effects of aperture displacement on the relative illumination profile of a sensor.

FIG. 10 is an illustrative schematic description showing how vignetting (shading in the image plane) is the result of a convolution in image space produced by variations of light intensity across the lens plane due to the aperture.

FIG. 11 is an illustration of a camera system showing shading effects due to ray angles.

### DESCRIPTION OF THE PREFERRED EMBODIMENTS

Each of the preferred embodiments of this invention is a method of implementing or improving the photographic capabilities of a camera by the appropriate use of its variable aperture apparatus. Therefore, the methods provided by these embodiments will effectively transform even a simple camera into a more flexible device and effectively increase its functionality and instrumentality.

### 1. First Embodiment

### Exposure Tuning

Referring first to FIG. 1, there is shown a schematic diagram illustrating the creation of an illuminated exemplary sensor pixel (10) at the sensor position of a prior art camera system by a corresponding illuminated object pixel located outside the camera. The object pixel (20) is at a distance V (the object distance) from the camera lens (15) and is illuminated by an exemplary source of illumination (80). The sensor pixel (10), of nominal dimension d, is at a distance behind the lens (the image distance), which is assumed to be approximately the focal length, f, of the camera lens. The camera lens is assumed to have an opening width, A, which is in this example also the aperture width. The illumination of the object at object distance V creates a light intensity at the object pixel that is characterized by an “illuminance at V” of an amount denoted as Iᵥ. The reflected light from the illuminated object pixel, characterized by the reflectivity, R, of the object pixel, in turn creates a light intensity at a pixel (10) of the camera sensor, which intensity is denoted the “faceplate illuminance” and symbolized Iᵢ. The faceplate illuminance is related to the illuminance at V, Iᵥ, by equation 1:

$${I}_{i} \approx \frac{{I}_{V} \cdot R \cdot T}{4 \cdot {( f \# )}^{2}} \qquad ( 1 )$$

In Equation 1, Iᵢ is the faceplate illuminance (the brightness at the image sensor), Iᵥ is the object illuminance at object distance V, R is the object's reflectivity, T is the lens' transmissivity, and f# is the lens' f-number (hereinafter symbolized f# in equations), which is the ratio of its focal length, f, to its aperture width, A. It is through this well known equation that increments in root-2 of the lens' f-number must correspond with increments of two in the exposure time to obtain a constant value of exposure, which is the product of the exposure time t and the faceplate illuminance Iᵢ.

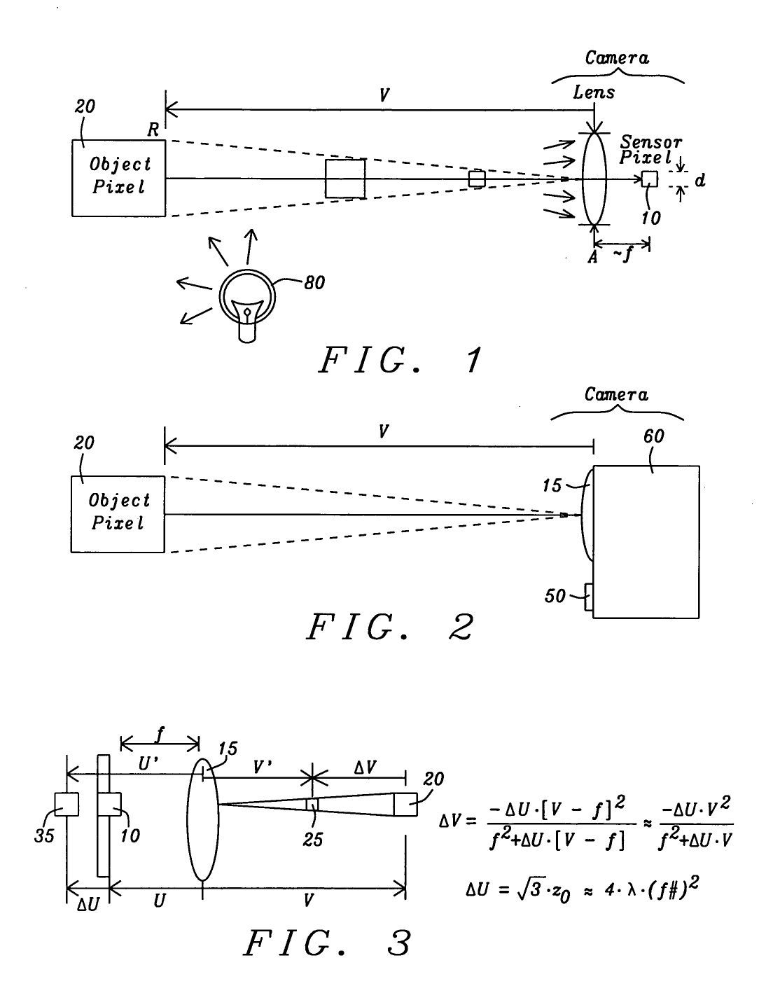

Referring to schematic FIG. 2, it will be shown how the method disclosed herein extends the use of Equation 1 beyond its application in the prior art, so that it can also be used in flash strobe-based camera systems. In flash-strobe-based illumination, the object pixel's (20) illumination drops off quadratically with distance as the illuminating strobe (50), here considered as a part of the camera (60), is considered a point source with an approximate pi-steradian light cone angle (not shown). Consider, now, Equation 2:

$${I}_{V} \approx \frac{{P}_{S}}{{V}^{2}} \qquad ( 2 )$$

In Equation 2, Pₛ is the power of the flash strobe and V is the object distance, which in the case where the strobe (50) and camera lens (15) are substantially at the same position, is simply the distance between the flash and the object. When Equations 1 and 2 are combined, the result is the expression for faceplate illuminance, Iᵢ given by Equation 3:

$${I}_{i} \approx \frac{{P}_{S} \cdot R \cdot T}{4 \cdot {( V \cdot f \# )}^{2}} \qquad ( 3 )$$

From Equation 3, it is seen that if the lens' f-number, f#, which is inverse to its aperture width A, (as in FIG. 1), is adjusted so that the f-number and the object distance are inversely proportional (see Equation 4 below), then as the object distance varies, the faceplate illuminance due to the flash strobe remains constant. This result greatly simplifies the calculation of exposure time. This simplification, in turn, enables the avoidance of over-exposure due to over-brightness of the flash on close objects or under-exposure due to under-brightness of the flash on far objects. Thus we have seen from the above analysis how the ability to adjust the aperture provides a corresponding ability to adjust (and compensate for) the disadvantages of an overexposure.

$$V ∝ \frac{1}{f \#} ∝ A \qquad ( 4 )$$

### 2. Second Embodiment

### Hyperfocal Distance Tuning

It is known in the prior art that the apparatus of a variable aperture can be used to adjust the diffraction properties of the image beams. This, in turn, allows adjusting the camera system's hyperfocal distance, H, which is the object distance at which maximum depth of field (maximum range of variation of an object's distance that still provides a sharply focused image) occurs for the given camera system. It is the purpose of the present embodiment to show how a camera having only a fixed focus system can nevertheless achieve the best possible focus, in terms of minimum optical spot size, by means of a variable size aperture.

Referring now to FIG. 3, there is shown, schematically, a lens (15) positioned between an object pixel (20) and a corresponding sensor pixel (10). The object pixel is located a distance V from the lens (the object distance) and the corresponding sensor pixel is located a distance U from the lens (the image distance). The focal length of the lens is indicated as f.

If the object pixel is moved to new position (25) which is a distance ΔV in front of its previous position so that it is now a distance V′ from the lens, its new image pixel (35) distance U′ will place it a distance ΔU beyond its previous image distance. The variation ΔV is denoted the depth of field of the lens (also referred to as the object defocusing distance) and it produces the corresponding depth of focus ΔU (also referred to as the image defocusing distance). As is stated above, the particular object distance V=H at which the maximum depth of field occurs is called the hyperfocal distance, H, of the lens. The result of applying the thin lens formula to the parameters in FIG. 3 is shown alongside the diagram in FIG. 3. Now, using the definition of H, there can be obtained a relationship between H and fundamental optical parameters of a camera as shown in Equation 5:

$$H = \frac{{f}^{2}}{4 \cdot λ \cdot {( f \# )}^{2}} = \frac{{A}^{2}}{4 \cdot λ} \qquad ( 5 )$$

In Equation 5, H is the hyperfocal distance, f is the lens' focal length, λ is the light wavelength (a typical central value being 0.55 microns) and A is the aperture's width as already used above.

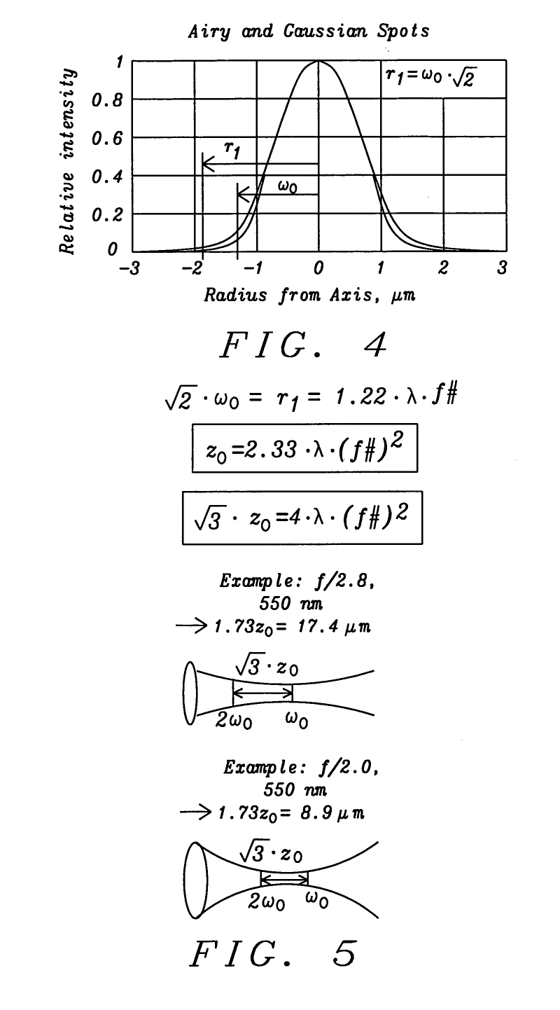

To make use of this optimal relationship between depth of field and hyperfocal distance for image quality tuning (i.e. to obtain the best possible focus), we first use the fact that the central lobe of an Airy disk (the optical diffraction limited form of a focused, incoherent light beam) can be very well fit to a Gaussian beam (the optical form of a propagating, coherent light beam) when the first dark ring in the Airy disk is at a radius, r₁, equal to root-two times the Gaussian beam's waist radius ω₀. This is shown graphically in FIG. 4 (where the outermost curve is the Gaussian) and is then given algebraically in Equation 6:

\sqrt{2}ω₀=r₁=1.22·λ·f# (6)

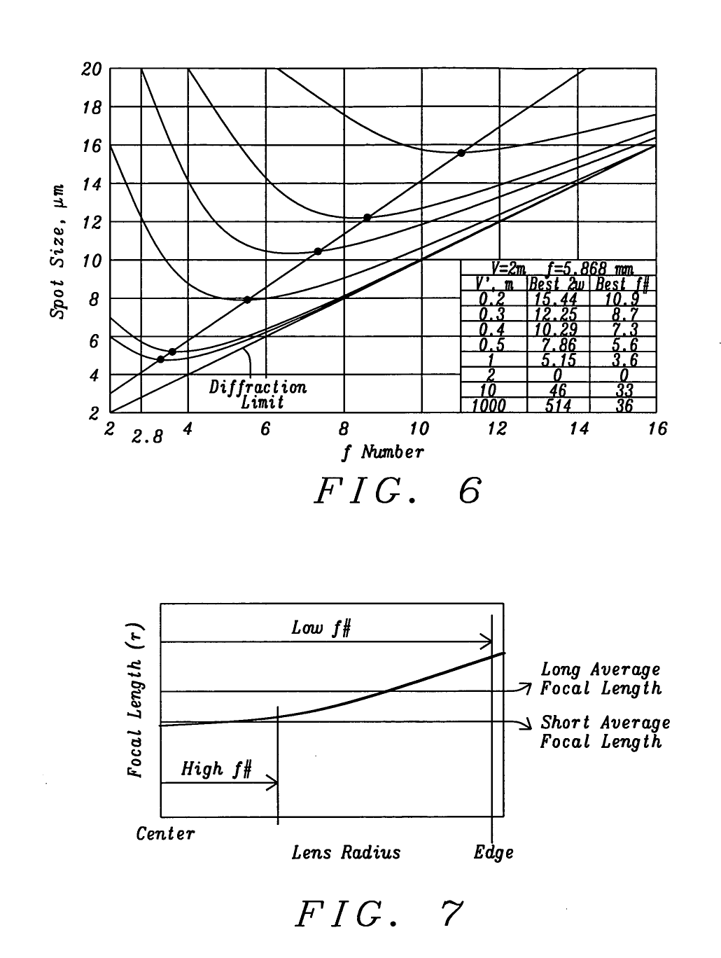

In Equation 6, ω₀ is the radius of the Gaussian beam's waist, r₁ is the radius of the Airy disk's first null as shown in FIG. 4, λ is the optical wavelength (as above) and f# is the lens' f-number (as above). FIG. 5 gives two illustrative examples showing the variation in the waist radii along a Gaussian beam for f/2.8 and f/2.0. In FIGS. 3 and 5 the term z₀ represents the distance you move to double the spot size.

Equation 6 allows a determination of the relation between the lens' f-number and the propagating Gaussian beam's spot size. Furthermore, using the thin lens equation in the context of the parameters shown in the illustration of FIG. 3, one can relate the defocus distance, ΔU, to V, ΔV and f; where V is a known object distance at best focus, ΔV is the defocus object distance, and f is the lens focal length.

When the result of Equation 6 is combined with the Gaussian beam and Airy disk equations displayed in FIG. 5 and FIG. 6, Equation 7 will result:

$$2 ω ( V , Δ V , f , f \# ) \approx ( f \# ) \cdot {( 1 + [ \frac{- Δ V \cdot {f}^{2}}{\begin{matrix}( {V}^{2} + V \cdot Δ V ) \cdot \\ ( 1.3 \cdot {[ f \# ]}^{2} )\end{matrix}} ] )}^{1 / 2} \qquad ( 7 )$$

Furthermore, the best-choice f-number, f#_{Best}, can be calculated by equating to zero the derivative of Equation 7 with respect to f#. f#_{Best} then indicates the f-number choice that will provide the minimum optical spot size on the image sensor when the camera system is focused to an object distance V but the object is actually positioned at a distance V′=(V+ΔV). The result is given in Equation 8:

$$f {\#}_{Best} \approx ( 0.84 ) \cdot \sqrt{\vert \frac{- Δ V \cdot {f}^{2}}{{V}^{2} + V \cdot Δ V} \vert} \qquad ( 8 )$$

In Equation 8, the units of length should be in microns. In corresponding fashion, this result (f#_{Best}) can be placed back into Equation 7 to calculate the spot size that results when the best f-number is used, as is shown in Equation 9:

$$2 {ω}_{Best} \approx ( 1.24 ) \cdot \sqrt{\vert \frac{- Δ V \cdot {f}^{2}}{{V}^{2} + V \cdot Δ V} \vert} \qquad ( 9 )$$

FIG. 6 is a graphical representation showing a range of curves that plot f-number (abscissa) vs. spot size (ordinate). In all cases, the focal length of the lens is 5.868 mm, the camera is focused at V=2 m, but the actual object position ranges from V′=0.2 m (top curve), through values of V′=0.3, 0.4, 0.6 and 1.0 m in the lower curves. The minimum value of each curve (dark dot) corresponds to the best value of the f-number, f#_{Best}. Thus, for V′=0.2, f#_{Best}=10.9.

In this manner, the present embodiment of the invention provides a method of using a fixed-focus imaging system (i.e., a lens with no auto-focus) in conjunction with a variable aperture (e.g., an ability to vary the lens' f-number) to obtain the best possible focus (minimum possible optical spot size) at an aperture setting of f#_{Best}. Furthermore, the invention can be extended so that the values of the obtainable minimum optical spot sizes can then also be calculated to determine how much, if any, image processing sharpening could be applied to a captured image to compensate for the degradation in optical spot size due to defocus and corresponding hyperfocal distance tuning to enable a partial refocus (e.g., a minimization of optical spot size). Alternatively, by adjusting the lens' f-number and seeking the highest image sharpness (minimum optical spot size), the best f-number can be found empirically and then used to calculate the object's actual distance, V′. This information is useful and advantageous, for example, for calculating the exposure time when using a flash strobe.

To emphasize the final point above, consider the combination of Equations 3 and 8, which will result in Equation 10:

$${I}_{i} \approx ( \frac{{P}_{S} \cdot R \cdot T}{2.8} ) \cdot ( \frac{- V}{( V + Δ V ) \cdot ( Δ V \cdot {f}^{2} )} ) \qquad ( 10 )$$

In Equation 10, V from Equation 3 was replaced by (V+ΔV), as necessary for coordination with Equation 8. From Equation 10 and the definition that an “optimal exposure time”, τ, is that time within which the product of τ and Iᵢ will remain constant and not fluctuate, then the optimal exposure time, τ, of the camera system can be calculated. This is given in Equation 11:

$$τ = k \cdot ( \frac{( V + Δ V ) \cdot ( Δ V \cdot {f}^{2} )}{V} ) \qquad ( 11 )$$

In Equation 11, k is a system constant. Equally, a limitation on ΔV is imposed such that |ΔV|ₘᵢₙ occurs when f#_{Best}=f#ₘᵢₙ for the optical system. In this manner, the invention provides the calculation of the optimized exposure time in a fixed focus camera system that correlates with the actual object distance, the best-focus object distance, the lens' focal length and the requisite f# for minimum spot size to provide a faceplate illuminance that is as constant as possible.

### 3. Third Embodiment

### Lens Focus Tuning

In this embodiment, the apparatus of a variable aperture is used to allow object light to access different portions of an imaging lens' radius. In conjunction with this capability, the camera lens is designed so that its focal length function is radially dependent (measured radially outward from the center of the lens within the plane of the lens), meaning that the lens' focal length at one radius on the lens is different than the lens' focal length at another radius on the lens. With this combination, the use of a variable size aperture will allow the camera to perform as though it was equipped with an auto-focus ability. Note that such radial variations can be accomplished by such means as varying the surface curvature of the lens or by varying the index of refraction of the lens material itself.

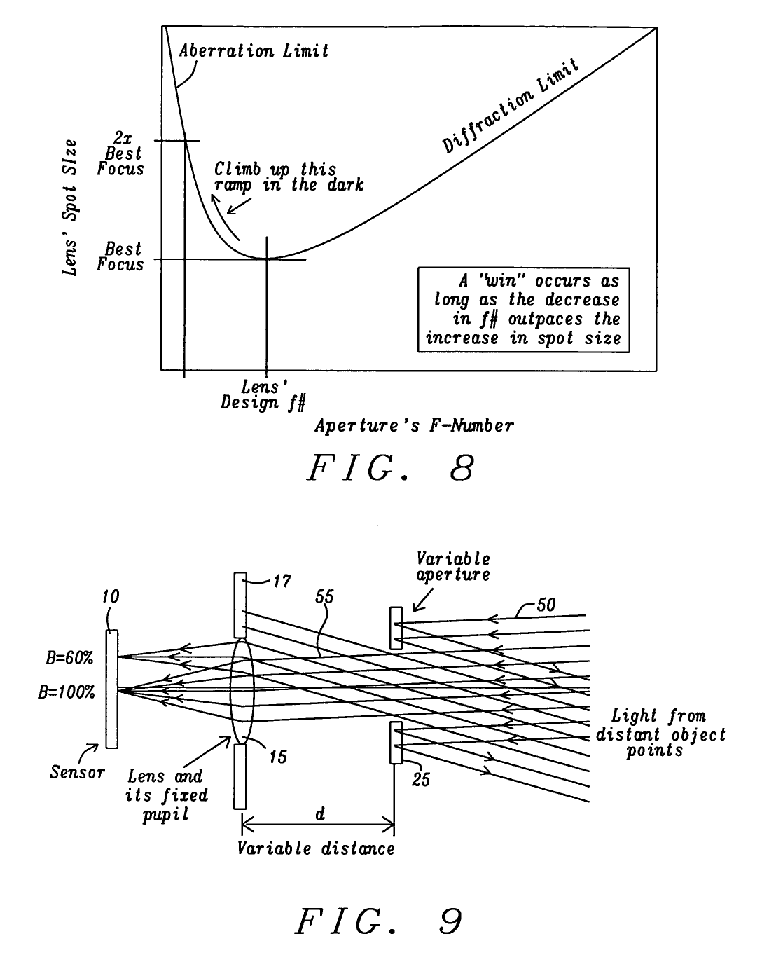

Referring to FIG. 7, there is shown a graphical construction that relates areas of optimal focus of a lens to the regions of the lens that possess different focal lengths.

Under conditions of radially-varying focal lengths, varying the aperture of such a lens will cause the average focal length of the lens to vary. Of course, this functionality comes at the expense of having more aberrations in the lens design. However, if the severity of the resulting aberrations, for a given aperture opening width, is less than the severity of defocus due to not refocusing a regular lens, then varying the aperture in this lens design can be a valid approach to imparting to the lens the property of auto-focus. Herein lies the method of this invention using a variable aperture apparatus.

Ideally, the radially-varying lens' focus function would offer an increase in focal length for a corresponding increase in aperture width (or decrease in lens f-number). In this manner, farther objects (which will create in-focus images closer to the lens) will be in focus better with low f-numbers (which also agrees with the previous embodiments of the invention that provided exposure tuning and hyperfocal distance tuning using variable apertures) while closer objects (which create in-focus images farther from the lens) will be in better focus with high f-numbers (which also agrees with the previous results in exposure tuning and hyperfocal distance tuning using variable apertures). See Equations 8 and 10.

It is further noted that the use of a variable aperture to allow the implementation of radial properties of a lens can also be applied to endow a camera system with special effects tuning. For example, special transmission functions (other than variable focal length, index of refraction, etc.), such as color or polarizability may be designed into a lens or into filters placed adjacent to a lens or into regions surrounding the perimeter of a lens, so that changing aperture widths affects the overall optical properties of the lens and camera system.

As with other approaches, post-capture processing can then be employed to deconvolve and/or otherwise sharpen the images to further enhance image quality.

### 4. Fourth Embodiment

### Sensitivity-Resolution Tuning

In the method of this embodiment, the apparatus of a variable aperture is used to tune the tradeoff between system sensitivity and system resolution under conditions of low light.

In very low lighting conditions, one of two approaches is typically exercised to capture an image with acceptable quality: 1) lengthen the exposure time, or 2) increase the analog gain of the sensor. In the first approach, long exposure times allow for good system signal to noise ratios, but such times are often are harmful to system image resolution due to motion blur, either from the hand motion of the user or from the object motion of the subject. Thus the sensitivity/resolution product may or may not improve.

In the second approach, short exposure times minimize motion blur, but the low signal to noise ratios that result from short exposures need to be improved by increasing the noise reduction filtering upon post processing (post-capture noise reduction), which blurs the image. Thus, even with this approach, the sensitivity/resolution product may or may not improve.

As an alternative, or at least as an addition to, the above two known prior art approaches, the disclosed method of the present embodiment offers a lens-aperture combination that can achieve a very low f-number. Furthermore, under normal lighting conditions, the variable aperture is closed down to the point where the lens' aberrations are acceptably low for quality imaging (for example, “diffraction limited” imaging).

The method and apparatus of this embodiment provides that during very low light imaging, the variable aperture can be opened up so that the lens achieves a very low f-number (well below the ideal design f-number). During this condition of low f-number, the native image can be captured in a shorter exposure time, so it has less motion-induced blur than in case 1 above. While the aberration in the lens at such low f-numbers may be too high for quality imaging under standard lighting conditions, under low lighting conditions, these aberrations may cause less blurring of the image than would motion artifacts or post-processing noise reduction artifacts. In this manner, a “win” in image quality would occur for this optical system over standard imaging systems.

Referring to FIG. 8, there is shown a graphical representation of the tradeoff between the limits to picture quality (as determined by spot size, measured along the ordinate) that result from lens aberrations, as the f-number decreases along the abscissa, and the limits to picture quality that results from diffraction limiting, as the f-number increases along the abscissa. As is shown in the figure, the minimum of the curve corresponds to the best focus that is produced by the f-number of the lens design. As the available light decreases, however, the f-number of the variable aperture system is decreased, introducing more in the way of lens aberrations, but, nevertheless, providing picture quality that is overall an improvement. As can be seen in the curve, the region to the left of the minimum offers the ability of using the variable aperture to decrease the f-number to improve low-light imaging, while not yet enlarging the spot size sufficiently to produce poor image resolution.

### 5. Fifth Embodiment

### Shading and Telecentricity Tuning

In this system application, the apparatus of a variable aperture is used to adjust the shading (relative illumination profile across the sensor) and/or telecentricity (ray angle profile) of an optical system.

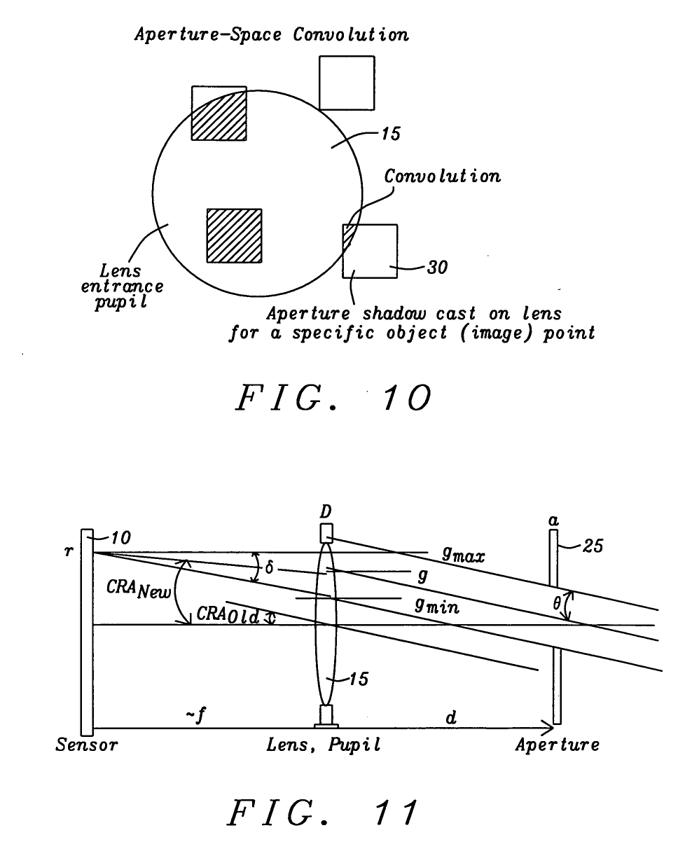

Referring to FIG. 9, there is shown schematically a sensor (10), a lens (15) having a fixed pupil (i.e. a fixed opening width) and a variable aperture (25) positioned a variable distance, d, in front of the lens. Light rays (50) from distant object points are shown impinging upon the variable aperture, with some of the rays passing through the aperture and some of the rays blocked by a frame or other physical limit that defines the aperture size. Of the rays that pass through the aperture, a fraction (55) also pass through the lens pupil and another fraction are blocked by a frame (17) or other mechanism supporting the periphery of the lens. The rays passing through the lens pupil strike the sensor at various positions and produce various degrees of light intensity or brightness, B, (B=60% at the sensor top, B=100% at the sensor center) across the sensor surface (the image-space). The sensor surface is thus brightest at its center and darkest at its edges, creating the visual appearance of a peripheral shadowing in the image-space, called “vignetting.”

Thus, because the variable aperture is placed away (at a variable distance d) from the lens' pupil plane, it effectively casts a shadow onto the lens' pupil according to the aperture's distance from the pupil, the aperture's width relative to the pupil's width and the aperture's shape relative to the pupil's shape.

Referring to FIG. 10, there is shown schematically how the effect of vignetting is produced by an exemplary square-shaped variable aperture (the aperture labeled (25) in FIG. 9). It is to be noted that differently shaped apertures will produce differently shaped shadings on the sensor, but the general principle discussed herein is equally applicable to all shapes.

Mathematically, the effect shown in FIG. 10 represents an aperture-space convolution. It shows the “position” of the aperture (i.e. the intensity distribution of the light passing through the aperture) at various positions on the pupil plane of the lens. Wherever the square image of the aperture is partially shaded (30), light passing through the aperture is also passing partially through the lens (15). This distribution of light intensities across the lens entrance pupil is produced by light rays entering the aperture at various angles from an external object (arrows (50) in FIG. 9). This variation of light intensity across the lens entrance pupil will then show up as a shadowing (vignetting) on the sensor (the image plane), as the light ultimately strikes the sensor.

The actual appearance of the image space can be obtained mathematically by an aperture-space convolution, which is essentially the light intensity within each square image (30) of the aperture integrated across the surface of the lens (the lens entrance pupil). Note that a product in aperture-space is a convolution in image-space.

In the disclosed method, a calculation of the convolution, given the size and shape of the variable aperture and the aperture-to-pupil distance, can be used to tune the shading profile that appears on the sensor and produce desired properties. It should also be noted that differently shaped variable apertures can, in a corresponding manner, be used to create asymmetric blur functions on the image plane, for aesthetic purposes.

Referring to FIG. 11, there is shown another effect, the “telecentricity, produced by the passage of light rays through the aperture of width, a, (25) and lens (15) of diameter D and their subsequent striking of the sensor (10).” This is a variation in ray angles and its effect on the light intensity striking the sensor (10) as indicated by the angle of the central ray, CRA (central ray angle), of a light cone as light passes through the aperture/lens combination. As a result of this change in the CRA, there is a variation of light intensity with image height that becomes visible in the produced image. Thus, by varying the aperture width and distance from the lens, the telecentricity can produce variations in shading in the image plane that are similar to the effects of vignetting discussed above, except that the vignetting is due to variations in light intensity across the lens entrance pupil while the telecentricity is a result of cone angle variations.

As is understood by a person skilled in the art, the preferred embodiments of the present invention are illustrative of the present invention rather than limiting of the present invention. Revisions and modifications may be made to methods employed in using a variable aperture in a camera to tune its optical properties, while still providing such methods in accord with the spirit and scope of the present invention as defined by the appended claims.

What is claimed is:

1. A method of using a variable aperture in a camera system to avoid over-exposure of the image of an object due to over-brightness of illumination on the object when it is close, or to avoid under-exposure of the image of the object when it is distant due to under-brightness of the illumination on the distant object, comprising:
providing a camera system including at least a lens, an image sensor and a variable aperture;
providing a source of illumination of an object external to said camera system and at a distance from said camera system, wherein light reflected from said object produces a faceplate illuminance at said image sensor; then calculating an exposure time based on a condition of constant faceplate illuminance, wherein said constant faceplate illuminance is produced by a variation in a width of said variable aperture; then
using said exposure time to adjust the exposure of said object whereby said exposure is correct for the distance of said object.

2. The method of claim 1 wherein the aperture width is adjusted so that the f-number, f#, of the camera system is inversely proportional to the object distance.

3. A method of using a variable aperture in a fixed-focus camera system to achieve the best possible focus of an external object, comprising:
providing a camera system including at least a fixed-focus lens, an image sensor and a variable aperture;
providing an object at an actual object distance V′ from said lens;
providing said lens focused at an object distance V; then determining a best f-number, f#_{Best}, to obtain a best focus for said object in terms of a minimum spot size; and
adjusting said variable aperture to obtain said minimum optical spot size for said focused distance V.

4. The method of claim 3 wherein obtaining said minimal optical spot size requires a tuning of hyperfocal distance.

5. The method of claim 3 further including a calculation of minimum optical spot size to obtain post-capture processing limits for defocus compensation.

6. The method of claim 3 wherein an empirical observation that minimal optical size has been obtained allows a subsequent determination of a best aperture size and a corresponding best f-number, f#_{Best}.

7. The method of claim 6 wherein said best aperture size is used to calculate a more precise value, V′, of said object distance V.

8. The method of claim 7 wherein the determination of the more precise value, V′, of said of said object allows a determination of an optimal exposure time, τ, during which time there will be minimal fluctuation of a faceplate illuminance of said object.

9. A method of using a variable aperture in a camera system to provide an effective auto-focusing ability to a lens having a radially varying focal length, comprising:
providing a camera system including a lens with a radially varying focal length, a variable width aperture and an image sensor;
placing an object at a distance from said camera system;
varying the of width of the aperture between said lens and an object, whereby the effective radius of said lens is altered and a corresponding average focal length is created; whereby
the object is focused on said image sensor.

10. A method of using a variable aperture in a camera system to provide special effects tuning, comprising:
providing a camera system including a lens, a variable width aperture, an image sensor and a transparent filter placed between said variable width aperture and said image sensor, wherein said filter has an optical property that varies radially with respect to a center of said filter;
placing an object at a distance from said camera system;
varying the of width of said aperture, whereby the effective radius of said filter is altered and a corresponding average optical property of said filter is created; whereby
an image of said object, modified by said average optical property, is focused on said image sensor.

11. The method of claim 9 wherein said optical property is color or polarizability.

12. A method of using a variable aperture in a camera system to tune a tradeoff between image resolution and system sensitivity under low light conditions, comprising:
providing a camera system including at least a lens, an image sensor and a variable aperture;
providing a curve of spot size vs. f-number;
determining a region of said curve wherein said f-number can be made to decrease below a minimum f-number corresponding to a lens design parameter;
setting said f-number within that region, whereby subsequent post-image processing enables a reduction of aberration blurring that is improved over the capabilities of reducing possible motional blurring.

13. A method of using a variable aperture in a camera system to tune the effects of vignetting in image space, comprising:
providing a camera system including at least a lens, an image sensor and an aperture having a variable width and having a variable distance in front of the lens;
varying said aperture width and distance to control the effects of vignetting on the image sensor, said vignetting being the result of an aperture-space convolution of light intensity passing through said aperture and said lens and impinging upon said image sensor.

14. The method of claim 13 wherein said variation of aperture width and distance also controls the effects of light ray angles striking said image sensor, thereby producing corresponding shading effects.
